(19) United States
(12) Patent Application Publication
(10) Pub. No.: US 2026/0200161 A1
(43) Pub. Date: Jul. 16, 2026

(54) METHOD AND DEVICE FOR CHECKING AN EXTRUSION APPARATUS

(71) Applicant: Sikora AG, Bremen (DE)

(72) Inventors: Hilmar Bolte, Bremen (DE); Harald Sikora, Bremen (DE); Sebastian Miesner, Ganderkesee (DE); Kolja Tobias Schuh, Bremen (DE)

(73) Assignee: Sikora AG, Bremen (DE)

(21) Appl. No.: 19/120,466

(22) PCT Filed: Aug. 14, 2023
(86) PCT No.: PCT/EP2023/072383

§ 371 Date: Mar. 13, 2026

(30) Foreign Application Priority Data
Oct. 13, 2022 (EP) 22201433.4

(51) Int. Cl. B29C 48/92; B29C 48/09

(52) U.S. Cl. CPC B29C 48/92; B29C 48/09; B29C 2948/92123; B29C 2948/92247; B29C 2948/92447; B29C 2948/92923

(57) ABSTRACT

A method for checking a setting of an extrusion device for a tubular strand includes measuring a refractive index of at least one wall of the tubular strand at a first measuring position when it has not yet solidified. Geometry values of the tubular strand at the first measuring position are measured at at least one measuring location on the top and bottom side of the tubular strand. A calibration correlation is determined between the refractive index at the first measuring position and a ratio of the exit widths for extruded material on the top and bottom side of the extrusion die. A ratio of the exit widths for extruded material on the top and bottom side of the extrusion die for the measured refractive index for a ratio of the geometry values measured on the top and bottom side of the tubular strand is compared with the calibration correlation.

### CROSS-REFERENCE TO RELATED APPLICATIONS

This is a U.S. National Application of PCT/EP2023/072383, filed Aug. 14, 2023, and claiming the priority and the benefit, under relevant portions of 35 U.S.C. § 119, of European Patent Application No. 22201433.4, filed on Oct. 13, 2022. The entire contents of these applications are hereby incorporated by reference.

### TECHNOLOGICAL FIELD

The following disclosure relates to embodiments of a method for checking the setting of an extrusion device, which produces a tubular strand conveyed along the longitudinal direction thereof, wherein the exit widths for extruded material on a top side and on a bottom side of an extrusion die of the extrusion device are set differently. The following disclosure also relates to embodiments of a device for carrying out the method.

### BACKGROUND

Plastic pipes for supplying residential and industrial areas with gas and water, but also for draining water, are predominantly manufactured from materials such as HDPE, PP, and PVC. Typical pipe diameters are up to 3 m, with wall thicknesses of up to 250 mm. The manufacture typically takes place in extrusion devices, in which a plastics pipe material is melted and discharged through a typically annular extrusion die. The pipe extruded in this manner is hauled off from the extrusion device and thus conveyed in the longitudinal direction. The diameter of the hauled-off pipe is shaped to the desired external diameter in a downstream, for example sleeve-shaped, calibration device. In the course of the conveying, the pipe generally passes through multiple cooling sections, in which the pipe is cooled and the initially still flowable plastics melt is thus successively solidified. In a first cooling section, the shaped pipe is prevented from collapsing by means of a vacuum, for example. The cooling of the pipe in the cooling sections frequently takes place using a cooling liquid such as water. The cooling water flows around the pipe and quickly solidifies the external region thereof. After exiting from the first cooling section, the external surface of the pipe is thus generally solidified, such that the external geometry of the pipe then substantially no longer changes. However, there are often still flowable portions of the pipe material inside the pipe wall after it has exited the first cooling section. In the further course of the conveying of the tubular strand, in particular in the course of travel through further cooling sections, the pipe interior is also successively cooled and thus solidified down to the internal surface of the pipe. The pipe is finally cut to the desired length with the aid of a flying saw.

The shaping of the pipe in the course of complete solidification upon exiting the extrusion device is substantially influenced by two effects which must be taken into account for the goal of achieving, for example, a wall thickness of the pipe that is as uniform as possible. Firstly, there is a shrinkage of the pipe material that occurs during the cooling. Secondly, there is sagging of the still flowable viscous mass portions during solidification due to the influence of gravity.

As a reaction to these effects influencing the final geometry of the tubular strand, it is known to set the extrusion die of the extrusion device to have a larger exit width for extruded material in a top region than in a bottom region. To set the exit width, an exit gap of the extrusion die can be set wider in the top region than in a bottom region. Alternatively or additionally, the extrusion die may be heated more strongly in a top region than in a bottom region and thus a larger exit width can be realized in the top region than in the bottom region of the extrusion die. On account of both measures, more material exits in the top region of the extrusion die than in the bottom region. This intentionally asymmetrical discharging of the material is intended to compensate for sagging, such that the solidified pipe has a wall thickness that is as constant as possible over the entire circumference thereof.

Important geometry values of the pipe, such as wall thickness and diameter, can finally only be measured after complete solidification, i.e. at the end of all cooling sections of the pipe, once shrinkage and sagging have fully taken place. A typical output rate of an extrusion device for medium pipe cross-sections is approximately 1,000 kg/h. The exit temperature of the melt from the extrusion die is approximately in the range of from 200° C. to 240° C., depending on the material. For a pipe having, for example, an external diameter of 330 mm and a wall thickness of 30 mm and a typical cooling section for the pipe of 60 m, initial measurement results for the wall thickness and the diameter are often only available hours after start of production. Only then can the production parameters of the extrusion device be influenced in the event that geometric deviations from nominal values are ascertained, wherein changes made can in turn only be checked again after several hours. Several corrections that are often required to obtain an optimal process after a process has started take several days in order, for example, to set the wall thickness so as to be constant over the circumference and to the nominal value thereof.

As explained, to compensate for the sagging, the exit width is larger in the top region than in the bottom region when the extrusion die is being set. In order to absolutely prevent the wall thickness from falling below a minimum value in the event of sagging as well, the sagging is often overcompensated, wherein empirical values are used. This ultimately leads to an unnecessarily large amount of material being discharged.

It is therefore desirable to draw conclusions on the expected shrinkage and expected sagging of a pipe produced in an extrusion device as early as possible. A measurement, for example, of the wall thickness and diameter of a pipe after the first cooling section may not correspond to the desired final values that would be present after complete cooling of the pipe, because at this point the wall of the pipe only has solidified material in the external region and still has recrystallizing portions and molten material in the interior. Subsequently, diameter and wall thickness values that must still undergo shrinkage and sagging are recorded at a measuring position downstream of a first cooling section. To speed up the start-up process and to further continuously ensure the nominal values, predicting the expected shrinkage and sagging values as early as possible is of great financial importance.

WO 2022/058081 A1 proposes a method for determining geometric parameters of a strand-shaped or planar object, by means of which method the shrinkage is predicted. For this purpose, in an establishing step, a correlation between the refractive index of the object and a shrinkage that takes place during solidification thereof is established. In a determination step, the refractive index and at least one geometric parameter of the not yet completely solidified object is determined, in particular downstream of a first cooling section of the object, and a geometric parameter in the completely solidified state of the object is calculated from the determined values in consideration of the correlation established in the establishing step. Therefore, the shrinkage of the material of the object is predicted in the course of solidification thereof and, based on this, a geometric parameter, for example a wall thickness, is calculated in the completely solidified state of the object.

By means of the method explained, the shrinkage can be reliably predicted and taken into account as one of the two effects that have a significant influence on the final geometry, wherein the measured values are advantageously already available shortly after the material has exited the extrusion device and the final geometric parameter can thus be calculated early on in order to prevent waste. However, the sagging as the second significant effect on the final geometry of the object cannot be predicted using the known method for reasons that will be explained in more detail below.

A method for establishing the sagging of a pipe extruded in an extrusion device is known from WO 2022/106180 A1. Here, the wall thickness of the pipe is measured over the circumference of the pipe and a wall thickness profile over the circumference of the pipe is created from the measured wall thicknesses. Sagging of the molten material is established from the frequency and/or amplitude of the created wall thickness profile. This method makes a reliable detection of sagging possible, but a prediction of the sagging is not possible with this method either.

Proceeding from the explained prior art, the object of the invention is therefore to provide a method and a device of the type mentioned at the outset and by means of which, in consideration of the sagging of a tubular strand produced in an extrusion device, the exit widths for extruded material set on the extrusion device can be reliably checked and, if necessary, corrected, in particular in real time and with a minimal time delay after the strand has exited the extrusion device.

### BRIEF SUMMARY OF THE INVENTION

Aspects of the following disclosure are directed to embodiments of a method for checking an extruding device. In some embodiments, the method includes measuring the refractive index over the cross-section of at least one wall of the tubular strand at a first measuring position downstream of at least one first cooling section for the tubular strand, at which the tubular strand has not yet completely solidified. In some embodiments, the measuring is done by means of a terahertz measuring apparatus. In some embodiments, the method includes measuring geometry values are further measured at the first measuring position at at least one measuring location on the top side and at at least one measuring location on the bottom side of the tubular strand, wherein the geometry values comprise the wall thickness and/or the internal and/or external diameter of the tubular strand. In some embodiments, the measuring is done by means of the terahertz measuring apparatus. In some embodiments of the method, for the measured refractive index and for a ratio of the geometry values measured on the top side and on the bottom side of the tubular strand, the ratio of the exit widths set on the extrusion device for extruded material on the top side and on the bottom side of the extrusion die is checked using a previously determined calibration correlation between the refractive index at the first measuring position and the ratio of the exit widths for extruded material on the top side and on the bottom side of the extrusion die.

Aspects of the disclosure are further directed to embodiments of a device for carrying out the embodiments of the disclosed method. In some embodiments, the device includes a terahertz measuring apparatus and an evaluation apparatus in communication with the terahertz measuring apparatus. In some embodiments, the evaluating apparatus is configured to check the ratio of the set exit widths for extruded material on the top side and on the bottom side of the extrusion die.

In some embodiments of the method according to the invention and the device according to the invention, the sagging still to be expected after the first measuring position, i.e. the sagging of the still flowable, viscous mass portions of the tubular strand exiting the extrusion device during solidification due to the influence of gravity, is predicted and, on this basis, the setting of the extrusion device can be checked and, if necessary, corrected. The tubular strand may be a pipe, for example a plastics pipe. The extrusion device comprises a, for example, fundamentally circularly annular extrusion die from which the previously melted plastics material exits. In some embodiments, after exiting the extrusion device, the tubular strand passes in a regular manner through multiple cooling sections, in which the strand material is successively cooled fully and thus completely solidified, for example by means of a cooling liquid such as water. For example, after exiting the first cooling section immediately following on from the extrusion device, the external surface of the tubular strand may already be solidified, and therefore the shaping of the external surface of the tubular strand is complete. However, inside the pipe wall, the material of the tubular strand still has recrystallizing regions and molten portions and is thus still flowable at least in part, wherein sagging occurs in addition to shrinkage in the further course of the cooling of the strand, as is known. For the final shaping of the tubular strand in the first cooling section, it is possible for the strand material to be pressed onto the, for example cylindrical, internal surface of a calibration sleeve in said first cooling section, for example by applying a vacuum.

In principle, however, in addition to the shrinkage, it is also possible to model the expected sagging proceeding from precisely known framework conditions and material properties of the tubular strand in a detailed manner by means of the Navier-Stokes equations. However, this is so numerically demanding that this is not practicable for a fast prediction of the sagging that is desired in the present case. Thus, according to the invention, a reliable prediction about the sagging still to be expected and thus about the final shape of the strand is intended to be available as early as possible after exit from the extrusion device in order to prevent waste, such that it is possible to intervene in the production process at an early stage if necessary, for example by adjusting the settings of the extrusion device. Preferably, the prediction of the sagging is intended to take place in real time. Both exclude the use of the Navier-Stokes equations, which are reliable per se, in this application scenario.

As already explained, unlike the shrinkage, the sagging cannot be predicted in the manner explained in WO 2022/058081 A1. The shrinkage from the extrusion temperature to complete cooling does not depend on the timeline of the solidification, in particular the cooling rate. Therefore, the shrinkage can be easily and reliably predicted by comparing the refractive index measured at the first measuring position with the cold value of the refractive index. Furthermore, the shrinkage cannot be substantially influenced by changing parameters, for example, of the extrusion device or the cooling parameters. It is substantially an unchangeable process property, but one which can be predicted relatively easily.

This is not the case with sagging, where the processes are far more complex than in the case of shrinkage. During sagging, the temperature-dependent flow behavior of the material, the temperature thereof, and the cooling rate initially play a significant role. In general, it can be stated that sagging of the melt during the production of pipes is more pronounced the higher the initial temperature of the melt and the more time that elapses until the melt has cooled and completely solidified. Variable operating conditions relating to the extrusion temperature, the throughput of the extruder, the haul-off speed, and the intensity and duration of the cooling influence the degree of the sagging. Whereas a system stop is sufficient for the shrinkage prediction using the refractive index, in which the change in refractive index together with the shrinking wall thickness and diameter are recorded over several hours of cooling, this reliable method does not work when predicting the sagging, precisely because the sagging of the wall thickness is much more pronounced or much less pronounced if the cooling takes place over a long or short period of time. Furthermore, the sagging—unlike the shrinkage—can be decisively influenced by changing the parameters of the extrusion device and the cooling parameters for the tubular strand.

To solve these problems, according to the disclosure, a (first) terahertz measuring apparatus is used, firstly, to measure the average or resulting refractive index over the cross-section of at least one wall thickness of the tubular strand at a first measuring position downstream of at least one first cooling section for the tubular strand, at which the tubular strand has not yet completely solidified, i.e. still has flowable recrystallizing and/or molten portions, and, secondly, to measure geometry values of the tubular strand, including the wall thickness and/or the internal and/or external diameter, also at said first measuring position, at at least two measuring locations on the top side and bottom side of the tubular strand. For this purpose, the terahertz measuring apparatus comprises a terahertz transmitter and a terahertz detector, which are arranged at substantially the same location and can also be combined into a transceiver in a particularly practical manner. The terahertz measuring radiation used according to the invention may, for example, be in a frequency range of from 1 gigahertz to 6 terahertz. Terahertz radiation is well suited for difficult measuring conditions in the environment of extrusion devices, in particular with the high temperatures, any contamination, and the occurrence of steam and the like. Thus, in contrast to laser radiation in the visible frequency range, for example, terahertz radiation is largely insensitive to such interferences. The terahertz radiation emitted by the transmitter of the terahertz measuring direction impinges on the tubular strand, for example, from above and/or from below.

In the process, some of the terahertz radiation is reflected on the external surface of the strand and some of the terahertz radiation passes into the strand material. This results in further reflections on boundary surfaces of the tubular strand, in particular the boundaries of the wall portions of the strand that face the transmitter and those that face away from the transmitter. Some of the terahertz radiation also exits the strand again on the side opposite the transmitter. Here, the terahertz measuring apparatus may comprise a reflector which reflects the terahertz radiation exiting the strand side facing away from the transmitter back to the strand again, such that said radiation makes it way to the detector arranged, for example, at the same location as the transmitter after further reflections on boundary surfaces of the strand, together with the remaining radiation components reflected on the boundary surfaces, and is detected as a measurement event by said detector.

In some embodiments, the refractive index can be determined from the detected radiation, as will be explained in more detail below, over the cross-section of one or second opposing wall portions of the strand at the first measuring position. The refractive index can be measured on the top side and/or on the bottom side of the strand. In particular, when radiation passes through two, for example opposing, wall portions of the strand, an average or resulting refractive index can be determined over both irradiated wall portions. Furthermore, as is known per se, the distances from the individual boundary surfaces of the strand can be determined, for example based on transit time measurements, from which distances geometric parameters such as wall thicknesses and/or internal and/or external diameters of the strand can in turn be determined. The measurement on the top side may, for example, take place at the highest point of the strand and the measurement on the bottom side may take place at the lowest point of the strand. In particular, the top wall thickness and the bottom wall thickness of the tubular strand may be measured at the first measuring position. These wall thicknesses will often differ, since—as explained at the outset—the extrusion device is generally set such that more material exits at the top side of the extrusion die than at the bottom side of the extrusion die in order to compensate for the sagging. This asymmetry is often still present in the region of the (first) terahertz measuring apparatus, i.e. in particular immediately downstream of the first cooling section.

In some embodiments, a previously determined calibration correlation is used for predicting the sagging that is still to be expected and the check of the extrusion device. The basis for using the calibration correlation is the refractive index measured at the first measuring position. The calibration correlation assigns the refractive index at the first measuring position to the ratio of the set exit widths for extruded material on the top side and on the bottom side of the extrusion die. The ratio of the exit widths on the top and bottom side of the extrusion die, as well as the ratio of the measured geometry values on the top and bottom side of the strand, can be specified as a simple number ratio or, for example, as a percentage. Since the strand as a rule still comprises regions with recrystallizing material and molten portions, thus in particular material that is still flowable, in the region of the first measuring position, the measured refractive index differs from the cold value thereof. The measured value of the refractive index provides information about the flowable portions, in particular recrystallizing portions and/or molten portions, still present inside the tubular strand at the first measuring position. The calibration correlation provides—in particular for defined geometric parameters of the strand at the first measuring position as well as defined production parameters of the extrusion device—an assignment between the refractive index measured at the first measuring position and a ratio of the exit widths of the extrusion die required for a desired strand geometry in the completely solidified state. This ratio of the exit widths, which is yielded according to the calibration correlation for the measured refractive index, can be compared with the ratio of the set exit widths of the extrusion device in order to check the extrusion device. As explained at the outset, the exit width can be set, for example, by setting an exit gap of the extrusion die and/or by triggering heating apparatuses of the extrusion die. It is conceivable, for example, for the basic setting of the exit widths to take place by setting the exit gap of the extrusion die and a later fine tuning or else adjustment of the exit widths then only by controlling the heating apparatuses of the extrusion die.

Merely detecting, for example, the wall thicknesses on the top and bottom side of the tubular strand at the first measuring position is not sufficient for the prediction according to the invention of the sagging still to be expected and thus for the check of the setting of the extrusion device. This is because a wall thickness ratio ascertained at the first measuring position at the top/bottom of the strand does not provide any information as to the extent to which previous sagging has already taken place or is even already complete. Only in combination with the evaluation of the (resulting) refractive index measured at the first measuring position and preferably the weighting thereof with respect to the wall thickness ratio measured at the first measuring position at the top/bottom can it be estimated whether complete compensation of the sagging will thus take place in the further course of the cooling sections, such that the strand has the specified wall thickness profile in the completely solidified state.

On account of the simplified approach according to the invention, the prediction of the sagging still to be expected downstream of the first measuring position and thus the check of the extrusion device can take place quickly and in real time, such that, for example, the extrusion device can be controlled accordingly quickly in order to set the exit of the strand material from the extrusion die, in particular on the top side and bottom side of the extrusion die, in such a way that the desired geometry of the strand is achieved in the completely solidified state. Often, the desired geometry of a tubular strand will be a geometry that is circular in cross-section with a constant wall thickness over the circumference.

In some embodiments, the calibration correlation may be stored in the form of a function or curve. In a particularly simple manner, the calibration correlation can be empirically established. For this purpose, for the relevant production process, when setting the exit widths of the extrusion die such that the tubular strand has a specified geometry over the circumference thereof after completely solidifying, for example a wall thickness that is constant over the circumference thereof, the measured refractive index that results at the first measuring position and the measured quotient of the geometry values, in particular of the wall thicknesses, on the top side and bottom side can be stored. In a later process, the refractive index measured at the first measuring position can then be compared with this stored refractive index. As is known, the refractive index is temperature-dependent. If the measured refractive index deviates from the stored refractive index, it can be assumed that there is a change in the temperature and thus, in particular, in the still flowable portions inside the strand at the first measuring position. Therefore, it can further be assumed that a correction of the set exit widths of the extrusion die is required in order to achieve the desired geometry of the strand in the solidified state. Further settings of the exit widths that result in the desired geometry of the strand in the solidified state can accordingly be stored for different refractive indices at the first measuring position when empirically creating the calibration correlation.

In particular, changes in the production parameters in the region upstream of the first measuring position can have a significant influence on the sagging and thus the geometry of the strand in the solidified state. Such changes occur, in particular, when a production process is started up after production downtime. These include, for example, a temperature of the extrusion die that increases slowly during the start-up or a change in the output rate of the extrusion device. Another example is a change in the cooling parameters, for example by changing the composition and/or temperature of the cooling liquid. Such changes can be recognized based not only on the refractive index measured at the first measuring position, but in particular also on the geometry values measured at the first measuring position. This is particularly because a significant proportion of the overall sagging has already taken place up to the exit from the first cooling section. According to the invention, it is thus possible to set optimal process parameters, in particular of the extrusion device, at a particularly early stage based on the calibration correlation when a production process is started up again.

Changes in the production process can be recognized not only based on the refractive index, but in particular also on the geometry values recorded at the first measuring position. If the geometry values recorded at the first measuring position change, it can be concluded that the expected sagging taken into account according to the calibration correlation has also changed. According to one embodiment, it can be provided that the calibration correlation is determined for defined geometry values of the tubular strand, for example at the first measuring position. It can then further be provided that, if a deviation of the geometry values measured at the first measuring position from the defined geometry values is ascertained, a warning is output and/or the calibration correlation is adjusted in accordance with the ascertained deviation of the geometry values. For example, the calibration correlation may be adjusted by a factor corresponding to the ascertained change. This factor can be adjusted based on empirical values, for example can be multiplied by a constant factor that takes account of the influence of the change on the sagging that occurs.

When establishing the calibration correlation, material parameters of the tubular strand, in particular the thermal conductivity and/or the thermal capacity, can be taken into account. Furthermore, production parameters, in particular the temperature of the extrusion die and/or the haul-off speed of the extrusion device and/or cooling parameters of the tubular strand produced, can be taken into account. Such parameters also have an influence on the sagging that occurs.

According to a further embodiment, the calibration correlation can assign the refractive index at the first measuring position to a nominal ratio of the exit widths for extruded material on the top side and on the bottom side of the extrusion die, so that the tubular strand has a nominal wall thickness profile, in particular a uniform wall thickness profile, over its circumference following its complete solidification. As already explained, the calibration correlation, for example established empirically, may be in the form of a function or curve. Here, the refractive index at the first measuring position can be plotted as a function of the ratio—to be set at the extrusion die as the nominal ratio—of the exit widths for extruded material on the top side and bottom side. In the simplest case, the curve may be a straight line with a negative slope. However, it may also be a curve that deviates from a straight line.

According to a further embodiment, if a deviation is ascertained between the resulting nominal ratio of the exit widths of the extrusion die for the refractive index measured at the first measuring position according to the calibration correlation and the ratio of the set exit widths of the extrusion die, the resulting nominal ratio for the measured refractive index according to the calibration correlation can be displayed. Alternatively or additionally, the extrusion device can be triggered in order to set the resulting nominal ratio for the measured refractive index according to the calibration correlation, preferably automatically. The triggering may be carried out by an evaluation apparatus. Therefore, automatic control of the extrusion device is possible. The display of the nominal ratio may take place on an operator display for an operator.

As already explained, an expected sagging of the tubular strand up to the complete solidification of the tubular strand can be predicted on the basis of a comparison of the geometry values measured at the first measuring position with the exit widths set on the extrusion device. The predicted sagging and/or expected values of the measured geometry values in the completely solidified state of the tubular strand can then in turn be displayed and/or the resulting nominal ratio of the exit widths for extruded material on the top side and on the bottom side of the extrusion die according to the calibration correlation can be adjusted on the basis of the predicted sagging.

According to a further embodiment, the refractive index and/or the geometry values can be measured at the first measuring position at a plurality of measuring locations over the circumference of the tubular strand. For this purpose, multiple terahertz transmitters and terahertz detectors, for example, can be arranged so as to be distributed over the circumference of the tubular strand. Preferably, a terahertz measuring apparatus that rotates about the tubular strand may be provided with a terahertz transmitter and a terahertz detector and optionally a reflector, by means of which terahertz measuring apparatus measured values can be generated in a distributed manner over the circumference. In particular, complete coverage of the circumference of the strand is conceivable, in principle, in this way. A more extensive measurement over the circumference, in particular also on the sides of the strand, offers further advantages compared with a measurement only from the top side and from the bottom side of the tubular strand. For example, this makes it possible to recognize solidification of the side walls of the strand that is potentially already further advanced and that could influence or rather prevent the still flowable portions from flowing down by the force of gravity and that thus could influence the sagging.

According to a further embodiment, the refractive index can be determined from a comparison of the transit time of measuring radiation emitted by the terahertz measuring apparatus without a tubular strand arranged in the beam path of the measuring radiation with the transit time of the measuring radiation with a tubular strand arranged in the beam path of the measuring radiation. This approach for determining an unknown refractive index of an object is described, for example, in EP 3 265 748 B1. The determination of the refractive index using the terahertz measuring apparatus can take place in a corresponding manner in the present case.

According to a further embodiment, the refractive index can be determined by determining the optical wall thickness of the tubular strand with the terahertz measuring apparatus, further by determining an external diameter and an internal diameter of the tubular strand with the terahertz measuring apparatus, and by determining the refractive index of the tubular strand from a comparison of the determined external and internal diameter with the determined optical wall thickness. This alternative way of determining an unknown refractive index is described in DE 10 2018 128 248 A1. Again, this approach is applicable in the present case.

According to a particularly practical embodiment, the geometry values of the tubular strand are determined from a transit time measurement of measuring radiation emitted by the terahertz measuring apparatus.

According to a further embodiment, at a second measuring position at a distance from the first measuring position in the longitudinal direction of the tubular strand, in particular a second measuring position downstream of the first measuring position at which the tubular strand has substantially completely solidified, the refractive index over the cross-section of at least one wall of the tubular strand and/or the wall thickness and/or the internal and/or external diameter of the tubular strand can be measured with a further terahertz measuring direction. Furthermore, at the second measuring position, the wall thickness and/or the internal and/or external diameter of the tubular strand on the top side of the tubular strand and the wall thickness on the bottom side of the tubular strand can be measured with the further terahertz measuring apparatus. The calibration correlation can be checked and, if necessary, corrected using the measurement results of the further terahertz measuring apparatus.

The second measuring position may, in principle, be located upstream or downstream of the first measuring position. Preferably, it is located downstream, and particularly preferably so far downstream that the tubular strand is substantially completely solidified. The further terahertz measuring apparatus may, in principle, be equipped like the (first) terahertz measuring apparatus provided at the first measuring position. The further terahertz measuring apparatus also comprises a (further) terahertz transmitter and a (further) terahertz detector, which may again be combined into a transceiver in a particularly practical manner. A reflector may again be arranged on the remote side of the tubular strand opposite the transmitter and, if applicable, the detector arranged at the same location. In a cost-effective manner, the further terahertz measuring direction may be arranged at a fixed position, in particular such that it emits terahertz radiation onto the tubular strand from above vertically downward or below vertically upward. It would also be conceivable for the further terahertz measuring apparatus to be a portable measuring apparatus, in particular a so-called handheld measuring apparatus, which is thus not arranged permanently at the second measuring position. The measurement of the refractive index and the above-mentioned geometric parameters can in turn take place in the manner explained above with regard to the terahertz measuring apparatus arranged in the first measuring position. At the second measuring position, in particular if the tubular strand has substantially completely solidified at this position, final material and geometric parameters of the strand can be measured, including the cold value of the refractive index. The measurement with a further terahertz measuring apparatus is substantially more accurate here than, for example, a measurement with a mechanical probe. The final parameters measured at the second measuring position may be compared with the parameters of the calibration correlation and the calibration correlation may be verified and, if necessary, adjusted on the basis of the actually measured final parameters.

With the above-mentioned embodiment, the dependence on material parameters of the model according to the invention is reduced. The material parameters are often not known or rather defined to a sufficiently precise extent, especially in the field of plastics strands. In order to reduce the dependence on material parameters, in the above-mentioned embodiment, an additional sensor may therefore be used, for example, to measure the cold value of the refractive index and the wall thickness at at least one angular position over the circumference of the strand or a ratio between at least two wall thicknesses at different angular positions, for example the ratio between the top and bottom wall thickness of the strand in the case of a terahertz measuring apparatus positioned in a fixed manner vertically above the strand. The calibration correlation used according to the invention can then be verified on the basis of the measured values of the further terahertz measuring apparatus in order, for example, to reduce deviations caused by material parameters that deviate from reality. In particular, any changes in the process temperature downstream of the first measuring position which, as explained, have an influence on the sagging can be recognized by means of the further terahertz measuring apparatus. A changed cooling rate of the strand is mentioned by way of example.

A correlation between the refractive index and the state of crystallization of the strand material can be used, for example empirically, to determine a sagging factor:

$$S F = k * {Δ}_{N}$$

with:
SF: sagging factor
k: factor
Δ_{N}: refractive index difference between the refractive index measured at the first measuring position and the cold value of the refractive index

The larger the sagging factor SF determined in this manner, the more pronounced the expected sagging. The volume and mass flow rate of the still flowable viscous material is approximately proportional to the sagging factor. With accurate knowledge of the cold value of the refractive index, the sagging factor and thus the calibration correlation can be determined more accurately.

Therefore, the model according to the invention for predicting the expected sagging can be improved further. In particular, the sagging factor at the relevant measuring position constitutes an indicator from which it is possible to derive the extent to which the often intentionally set difference between the wall thickness exiting the extrusion die in the top region and in the bottom region will still change in the further course of the extrusion line. On this basis, by setting the annular gap of the extrusion die and/or a suitable temperature of the extrusion die of the extrusion device, the sagging factor SF can be preset at the measuring location of the terahertz measuring apparatus such that the desired, generally uniform wall thickness of the strand over the entire circumference is yielded with the remaining sagging.

According to a further embodiment, it can be provided that the calibration correlation further assigns the refractive index at the first measuring position to a ratio of the wall thicknesses on the top side and on the bottom side of the tubular strand at the first measuring position, wherein a weighting factor is utilized to convert between the ratio of the wall thicknesses on the top side and on the bottom side of the tubular strand at the first measuring position and the nominal ratio of the exit widths for extruded material on the top side and on the bottom side of the extrusion die, which weighting factor takes into account a different degree of sagging upstream of the first measuring position and downstream of the first measuring position. Therefore, a weighting can be defined between the sagging of the strand that has already taken place and that is ascertained by measuring the geometry values at the first measuring position, and the sagging still to be expected afterwards up to complete solidification. The sagging that has already taken place is yielded from the comparison of the geometry values measured at the first measuring position with the exit widths set at the extrusion die. If, for example, it is assumed that this will continue after the first measuring position, but to a lesser extent, the sagging still to be expected can be predicted by multiplying the sagging that has already taken place by a number less than 1 in consideration of the refractive index measured at the first measuring position.

Conversely, a weighting factor can be formed which indicates the degree to which the sagging is greater upstream of the first measuring position than the sagging downstream of the first measuring position. For example, by forming a first quotient of the vertical gap dimensions of the extrusion die in the top and bottom region and a second quotient of the wall thicknesses in the top and bottom region measured at the first measuring position, two quotients can be compared with one another, for example a quotient can be formed from the first and second quotients. This quotient can then form the weighting factor. Since the majority of the sagging takes place between the exit from the extrusion device and the first measuring position, and thereafter the sagging is generally less pronounced, the weighting factor will thus generally be greater than 1. By way of example, the weighting factor may be approximately 3. The typically desired uniform wall thickness of the strand over the circumference can be obtained for a particular strand material and constant production conditions on the basis of a weighting factor of this kind. By means of this weighting factor or else a weighting quotient formed by means of conversion, the refractive index at the first measuring position can be assigned in the calibration correlation either to the ratio, measured at the first measuring position, of the wall thicknesses of the strand on the top side and bottom side thereof or to the nominal ratio of the exit widths on the top side and bottom side of the extrusion die of the extrusion device. It is therefore possible to directly find and specify the offset to be set at the extrusion die based on the geometry values measured at the first measuring position and on the measured refractive index. The exit widths of the extrusion die can therefore be controlled in an open-loop or else closed-loop manner directly on the basis of the measured values obtained at the first measuring position.

If a further terahertz measuring apparatus is provided at a second measuring position downstream of the first measuring position, the measured values thereof can be used to fine-tune the model according to the invention and thus the extrusion device. This utilizes the fact that, at the first measuring position downstream of a first cooling section, the melt has already cooled to such an extent that, in addition to a cooled outer zone, there is still a portion of recrystallizing melt inside the strand, in particular inside the pipe wall. It is then also possible to form a third quotient of the wall thicknesses in the top and bottom region measured at the second measuring position of the second terahertz measuring apparatus 27, i.e. in the completely solidified state. This third quotient, which should ideally be 1, for example, can then be compared with the first and second quotients. Similarly, a quotient could be formed from the refractive index measured at the first measuring position and the (cold value of the) refractive index measured at the second measuring position.

In the device according to the invention, the measured values of the terahertz measuring apparatus and, if applicable, of the further terahertz measuring apparatus are available at the evaluation apparatus. The evaluation apparatus is designed to carry out the evaluation and check according to the invention. It is, in particular, also designed to carry out the embodiments according to the dependent claims of the method according to the invention. For this purpose, the evaluation apparatus may comprise a control apparatus, in particular for controlling the extrusion device, in particular the extrusion die, in the manner explained above. The device may accordingly also comprise the further terahertz measuring apparatus. The device may also comprise the extrusion device.

### BRIEF DESCRIPTION OF THE DRAWINGS

An exemplary embodiment of the invention is explained in more detail below based on the figures.

FIG. 1 schematically illustrates and embodiment of a device for carrying out embodiments of the method according to aspects of the invention.

FIG. 2 schematically illustrates a partial sectional view of the embodiment of FIG. 1.

FIG. 3 graphically illustrates a temperature dependence of the refractive index.

FIG. 4 graphically illustrates an example of the variability of the refractive index over the radial position within the wall of a pipe that has not yet completely solidified.

FIG. 5 graphically illustrates an embodiment of the calibration correlation according to the invention.

FIG. 6 graphically illustrates a temperature distribution in the radial direction within the wall of a pipe that has not yet completely solidified.

FIG. 7 graphically illustrates wall thicknesses measured at the first measuring position over the circumference of a tubular strand.

Unless otherwise indicated, the same reference signs denote the same objects in the figures.

### DETAILED DESCRIPTION

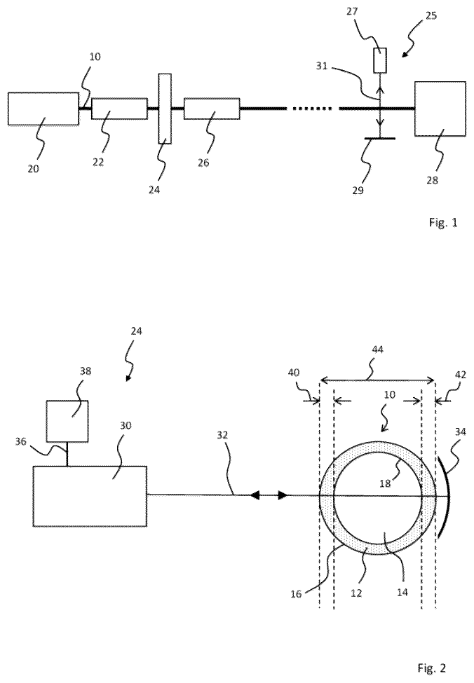

In FIGS. 1 and 2, a tubular strand 10, in the present case a pipe 10, in particular a plastics pipe 10, is represented, which comprises a wall 12, a cavity 14 delimited by the pipe 10, an external surface 16 that is circular in cross-section, and an internal surface 18 that is also circular in cross-section and that delimits the cavity 14. In the present example, the pipe 10 is extruded by means of an extruder in an extrusion device 20 and conveyed by means of a suitable conveying apparatus along its longitudinal axis, from left to right in FIG. 1. After exiting the, for example annular, extrusion die of the extrusion device 20, the pipe 10 firstly passes through a first cooling section 22, in which the pipe 10, which exits the extrusion die strongly heated and not yet completely solidified, i.e. still comprises recrystallizing and flowable portions (melt), is cooled. The first cooling section 22 may comprise a calibration apparatus, in particular a calibration sleeve, against which the pipe 10 is pressed, for example by means of a vacuum and the normal pressure inside the pipe 10. As a result, the external diameter of the pipe 10 pre-shaped by means of the extrusion die is definitively set. In the further course, the pipe 10 passes through a first terahertz measuring apparatus 24, in which the refractive index and geometric parameters of the pipe 10, for example internal and/or external diameter and/or wall thickness, are determined in the manner explained in more detail below. After the first terahertz measuring direction 24, the pipe 10 passes through at least one further cooling section 26, in which further cooling takes place. The dashing of the pipe 10 illustrates that further cooling sections 26 may be provided. After the pipe 10 has solidified completely, it is cut to length into specified portions in a length-cutting apparatus 28 comprising, for example, a flying saw.

The configuration and function of the first terahertz measuring apparatus 24 will be explained in more detail based on FIG. 2. In the example shown, the first terahertz measuring apparatus 24 comprises a transceiver 30, in which a transmitter and a detector for terahertz radiation are combined. The transmitter emits terahertz radiation 32 onto the pipe 10. The terahertz radiation is reflected on different boundary surfaces of the pipe 10 and on a reflector 34 arranged opposite the transceiver 30 and arrives back at the transceiver 30, where it is detected by the detector. The transceiver 30 is further connected via a line 36 to an evaluation apparatus 38. The reflected radiation received by the detector generates corresponding measurement signals, which are forwarded via the line 36 to the evaluation apparatus 38. In this way, the evaluation apparatus 38 can determine, for example, the wall thicknesses 40, 42 drawn in FIG. 2 as well as the internal and/or external diameter 44, for example based on transit time measurements. The evaluation apparatus 38 can also determine the refractive index of the strand material on the basis of the measurement signals received from the detector, as described, for example, in WO 2016/139155 A1 or DE 10 2018 128 248 A1.

The first terahertz measuring apparatus 24 determines, for example, the external diameter 44 and the wall thicknesses 40, 42 of the pipe 10 as well as the refractive index at the first measuring position shown in FIG. 1, at which the pipe 10 has still not completely solidified, i.e. still comprises flowable portions. In the process, the transceiver 30 may, for example, rotate in a circular path about the pipe 10 and thus determine the geometric parameters and the refractive index at various locations over the circumference of the pipe 10. The reflector 34 may also rotate about the pipe 10. However, it is also possible to dispense with the reflector 34.

A further terahertz measuring apparatus 25 is located between the at least one further cooling section 26 and the length-cutting device 28. The further terahertz measuring apparatus 25 also comprises a transceiver 27, in which a transmitter and a detector for terahertz radiation are combined. A reflector 29 for terahertz radiation is in turn arranged on an opposing side of the pipe 10. Said reflector reflects terahertz radiation 31 emitted by the transmitter back to the detector after it has passed through the pipe 10 and been reflected on boundary surfaces of the pipe 10.

As will be explained in more detail below, the further terahertz measuring apparatus 25 measures the refractive index and at least the wall thickness of the pipe 10 on the top side and bottom side at a second measuring position at which the pipe 10 has substantially completely solidified. The measurement of the refractive index and of the geometric parameters, such as the internal and/or external diameter and/or the wall thickness of the pipe 10, may take place by means of the further terahertz measuring apparatus 25 at the second measuring position shown in FIG. 1 in the manner explained above in relation to the first terahertz measuring apparatus 24, in this case at a measuring position at which the pipe 10 has substantially completely solidified. In a particularly simple manner, the further terahertz measuring apparatus 25 may be arranged at a fixed position and merely emit terahertz radiation onto the pipe 10 vertically from above or below, such that the above-mentioned geometric parameters, in particular the wall thicknesses on the top side and bottom side of the pipe 10, can be measured. The further terahertz measuring apparatus 25 may also be a portable hand-held device.

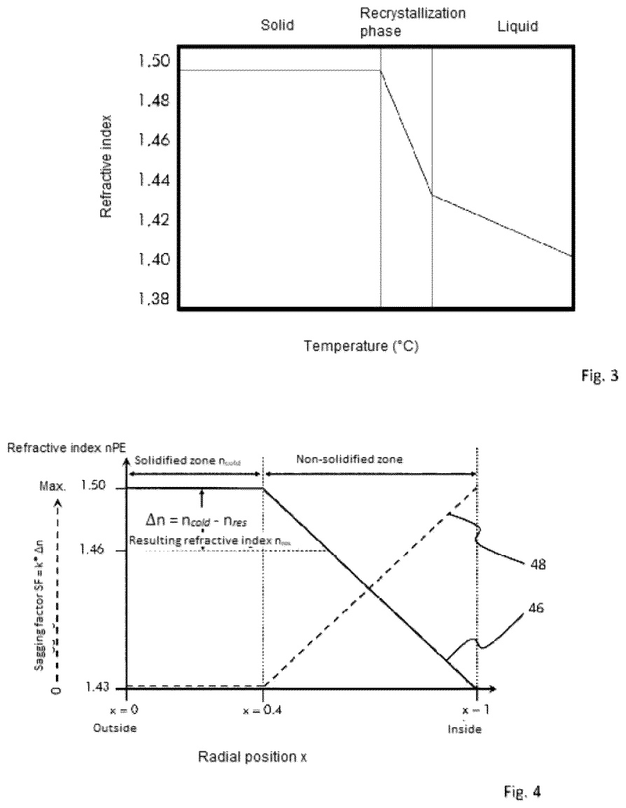

FIG. 3 shows the dependence of the refractive index on the temperature or rather state of aggregation. Firstly, it can be seen that the correlation between the refractive index and the temperature or rather state of aggregation is not linear. Secondly, it can be seen that the refractive index changes particularly significantly in the recrystallization phase, i.e. at the transition between the solid and the liquid state of aggregation. This is utilized in the method according to the invention in that conclusions are drawn from the refractive index measured in each case as to the remaining proportion of material in the recrystallization phase and, if applicable, in the liquid state and, from this, a sagging still to be expected after the measurement at the first measuring position is deduced.

In FIG. 4, the refractive index is plotted very schematically over the radial position x over the wall thickness. A range from 0 to 1 is plotted on the x-axis, wherein the wall thickness 0 accordingly applies at the external surface and the value 1 applies at the internal surface of the wall in question pertaining to the pipe 10. The curve 46 shown in FIG. 4 as a solid line shows the refractive index. Said refractive index is shown to be constant in the range of the solidified zone, i.e. in the range of from approximately 0 to 0.4 on the x-axis, and corresponds to the cold value of the refractive index n_{cold}, in the present case 1.5, for example. In the non-solidified zone that follows on, when looking radially inward, the refractive index decreases to a minimum value, of approximately 1.46 in the present case. It should be noted that the actual profile of the refractive index, in particular in the range of the non-solidified zone, does not actually have to be linear. At the dashed horizontal line in FIG. 4, a resulting refractive index nᵣₑₛ measured, for example, at the first measuring position over the cross-section of at least one wall of the pipe 10, is 1.46, for example. By comparing this with the cold value of the refractive index n_{cold}, it is possible to deduce that some of the strand material is still in the recrystallization phase and, if applicable, flowable in the form of melt. In the present case, the graphs of FIGS. 3 and 4 were created based on the example of a polyethylene as the pipe material, in particular a HDPE.

The refractive index difference between the measured refractive index and the cold value of the refractive index is thus:

$$Δ n = {n}_{cold} - {n}_{res}$$

A sagging factor SF=k*Δn, with a factor k, can be determined for various values of this refractive index difference, the curve profile of which is shown very schematically as a dashed line at reference sign 48 in FIG. 4. In the example shown, the sagging factor SF behaves in a substantially complementary manner to the resulting refractive index nᵣₑₛ. The actual profile of the sagging factor SF may deviate from this linear profile. The actual profile may, for example, be established empirically within the scope of a series of experiments for the respectively manufactured tubular strand.

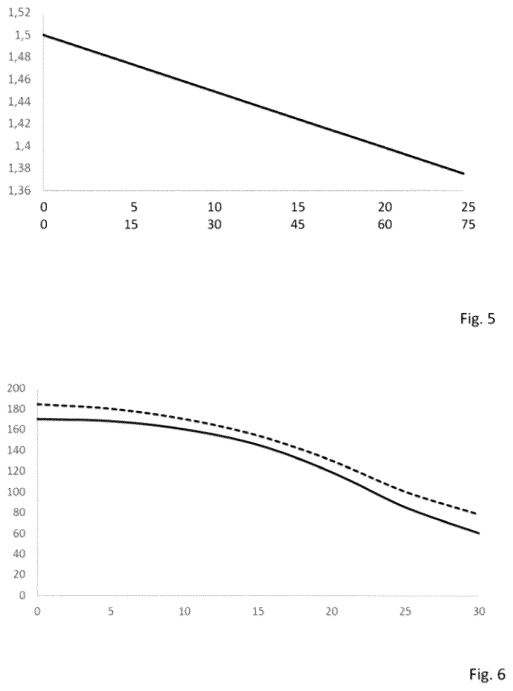

By way of example, FIG. 5 shows a calibration correlation used according to the invention. Said calibration correlation assigns the refractive index at the first measuring position to a ratio of the exit widths on the top side and bottom side of the extrusion die of the extrusion device 20 for extruded material. In FIG. 5, the refractive index at the first measuring position is plotted on the y-axis. The ratio of the wall thicknesses of the pipe 10 on the top side and bottom side thereof, i.e. the offset between the measured wall thicknesses on the top side and bottom side, measured at the first measuring position, is plotted in percent on the top row of the x-axis. The associated nominal ratio of the exit widths on the top side and bottom side of the extrusion die of the extrusion device 20, i.e. the offset between the exit widths on the top side and bottom side, is plotted in percent on the bottom row of the x-axis. At the cold value of the refractive index of 1.5, the start value 0% indicates, in each case, a required difference of zero for the exit widths on the top and bottom side of the extrusion die as well as for the wall thicknesses measured at the first measuring position on the top and bottom side. This is because no sagging is expected in this purely theoretical case. The values in the top row of the x-axis in FIG. 5, which are higher than 0, indicate the difference (offset), required for the desired pipe geometry in the completely solidified state, of the wall thicknesses of the pipe 10 measured at the first measuring position on the top and bottom side for lower refractive indices in each case, i.e. when the pipe 10 still has flowable portions. Therefore, a value of 5% means that the top wall thickness is 5% larger than the bottom wall thickness, and a value of 10% means that the top wall thickness is 10% larger than the bottom wall thickness.

The associated required difference (offset) of the exit widths on the top and bottom side of the extrusion die, indicated by the bottom row of the x-axis in FIG. 5, is yielded by multiplying the offset at the first measuring position by a weighting factor that takes account of the different sagging upstream and downstream of the first measuring position, as explained above. As explained above, the weighting factor takes account of the degree to which the sagging between the extrusion device 20 and the first measuring position is higher than the sagging that still takes place after the first measuring position. In the example shown in FIG. 5, a weighting factor of 3 was assumed. This weighting factor can be empirically established in the manner explained. The calibration correlation can, for example, be empirically established in the manner explained above. It can further be determined for defined geometry values of the pipe 10 at the first measuring position in the manner explained above. The calibration correlation thus indicates the nominal ratio of the exit widths on the top side and bottom side of the extrusion die of the extrusion device 20 for the refractive index of the pipe 10 measured at the first measuring position, which nominal ratio leads to a specified geometry of the pipe 10 in the completely solidified state, in particular to a uniform wall thickness over the circumference of the pipe 10. As can be seen in FIG. 5, the refractive index decreases with an increasing ratio between the exit widths on the top side and bottom side of the extrusion die.

FIG. 6 shows, for illustrative purposes for two different refractive indices measured at the first measuring position, the radial temperature profile within a wall of the pipe 10 from the inside outward as it occurs at the first measuring position of the first terahertz measuring apparatus 24. Here, the temperature in ° C. is plotted over the radial position, for example in mm. The solid curve corresponds to a larger measured refractive index than the dashed curve. Accordingly, the temperature profile represented by the dashed curve is higher than the temperature profile represented by the solid line. The temperature on the outside of the pipe is significantly cooled and solidified on account of the cooling liquid applied to the outside in the first cooling section 22. In contrast, the temperature increases strongly radially inward, since the cooling of the external wall has not yet cooled these regions to solidification. Here, there are thus still flowable portions. Above approximately 120° C., the material is flowable and thus sagging occurs.

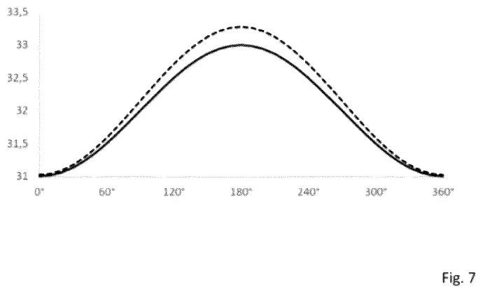

FIG. 7 shows wall thicknesses measured at the first measuring position over the circumference of the pipe 10 by way of example for two different cases, wherein the wall thickness of the pipe 10 in mm is plotted over the angular position in °. 180° is the top side of the pipe and 0° as well as 360° is the bottom side. The dashed line corresponds, for example, to the temperature distribution shown dashed in FIG. 6 and the solid line corresponds, for example, to the temperature distribution shown solid in FIG. 6. The curves shown in FIG. 7 were empirically established and lead, in each case, to a uniform wall thickness over the circumference of the pipe 10. It can be seen that, to compensate for the sagging, a greater deviation (offset) of the exit width on the top side of the pipe 10 (180°) from the bottom side of the pipe 10 (0°) is required for the higher temperature distribution than in the case of the lower temperature distribution. For example, in the case of the solid line for the desired pipe geometry in the completely solidified state, an offset of the wall thicknesses at the top/bottom of approximately 6.4% (33 mm to 31 mm) is required. From the calibration correlation according to FIG. 5, this corresponds to a refractive index at the first measuring position of approximately 1.46. Thus, if a refractive index of 1.46 is measured at the first measuring position, the ratio of the wall thicknesses at the top/bottom measured at the first measuring position must be 1.064, or 6.4% in percent of the offset. By means of conversion with the weighting factor in the manner explained above, this means that the ratio of the exit widths for extruded material at the extrusion die must be 1.192, or 19.2% in percent of the offset. This ratio thus constitutes the nominal ratio to which the extrusion die should be set. Corresponding, different values which in turn correspond to a different refractive index in FIG. 5 are yielded for the dashed line in FIG. 7. By carrying out a plurality of measurements, as shown in FIG. 7, the calibration correlation according to FIG. 5 can be empirically formed, wherein it is possible, for example, to interpolate between individual measured values.

In order to carry out the method according to the invention using the device according to the invention represented in the figures, the refractive index over the cross-section of at least one wall of the pipe 10 and geometry values, in particular the wall thickness and/or the internal and/or external diameter, of the pipe 10 are measured, as explained above, by means of the first terahertz measuring apparatus 24 at the first measuring position immediately downstream of the first cooling section 22 at a plurality of measuring locations distributed over the circumference of the pipe 10. Based on the measurement of the geometry values, it is preferably checked whether the geometry values present at the first measuring position correspond to the geometry values for which the calibration correlation was created. If this is not the case, a warning can be output or the calibration correlation can, for example, be changed by a factor corresponding to the ascertained deviation of the geometry values.

Furthermore, the nominal ratio of the exit widths on the top side and bottom side of the extrusion die of the extrusion device 20 that is yielded according to the calibration correlation is ascertained by means of the calibration correlation shown in FIG. 5 for the refractive index measured at the first measuring position and the geometry values measured at the first measuring position, and said nominal ratio is compared with the actually set ratio of the exit widths on the top side and bottom side of the extrusion die of the extrusion device 20. If these ratios differ from one another, a warning can be output and/or the extrusion device 20 can be triggered such that the ratio of the exit widths on the top side and bottom side of the extrusion die is adapted to the nominal ratio that is yielded according to the calibration correlation. This triggering of the extrusion device 20 may take place automatically. The measured values of the terahertz measuring apparatus 24 are available at the evaluation apparatus 38. The calibration correlation can also be stored in the evaluation apparatus 38. The evaluation apparatus 38 can carry out the evaluation explained and, if applicable, the triggering of the extrusion device 20.

Moreover, the refractive index and/or the wall thickness and/or the internal and/or external diameter of the pipe 10 is/are measured by means of the further terahertz measuring apparatus 27 at a second measuring position arranged downstream of the first measuring position and at which the pipe 10 has substantially completely solidified. For example, the refractive index at the second measuring position, which may in particular correspond to the cold value of the refractive index, as well as the wall thickness of the pipe 10 at least on the top side and bottom side thereof can be measured by means of the further terahertz measuring apparatus 27. The measurement results of the further measuring apparatus 27 are also available at the evaluation apparatus 38. Based on the measured values of the further terahertz measuring apparatus 27, which correspond to the final parameters of the pipe 10 due to the fact that the pipe 10 has already solidified substantially completely, the calibration correlation used as well as the cold value of the refractive index and the predicted sagging can be checked and, if necessary, corrected using the actual parameters of the pipe 10. This takes place by means of the evaluation apparatus 38. If necessary, the calibration correlation can be adjusted on this basis.

As explained, the extrusion device 20 can be triggered by means of the evaluation apparatus 38, which may comprise a corresponding control apparatus for this purpose, on the basis of the evaluation according to the invention of the measured values and drawing on the calibration correlation. In particular, the ratio of the exit widths for extruded material on the top side and bottom side of the extrusion die of the extrusion device 20 can be set in the explained manner by means of the evaluation apparatus 38 such that, in the solidified state of the pipe 10, the desired wall geometry of the pipe 10, in particular a wall thickness that is as uniform as possible over the circumference, is produced. For this purpose, the gap width of the annular exit gap of the extrusion die on the top side and bottom side of the extrusion die, for example, can be set accordingly by means of the control apparatus of the evaluation apparatus 38. It is also possible to influence heating elements of the extrusion die in a suitable manner by means of the control apparatus of the evaluation apparatus 38.

List of reference signs

| | |
|---|---|
| 10 | Pipe |
| 12 | Wall |
| 14 | Cavity |
| 16 | External surface |
| 18 | Internal surface |
| 20 | Extrusion device |
| 22, 26 | Cooling section |
| 24 | Terahertz measuring apparatus |
| 25 | Further terahertz measuring apparatus |
| 27 | Transceiver |
| 28 | Length-cutting device |
| 29 | Reflector |
| 30 | Transceiver |
| 31 | Terahertz radiation |
| 32 | Terahertz radiation |
| 34 | Reflector |
| 36 | Line |
| 38 | Evaluation apparatus |
| 40, 42 | Wall thicknesses |
| 44 | Diameter |
| 46 | Refractive index curve |
| 48 | Sagging factor curve |

1-18. (canceled)

19. A method for checking a setting of an extrusion device which produces a tubular strand conveyed along a longitudinal direction, wherein exit widths for extruded material on a top side and on a bottom side of an extrusion die of the extrusion device are set differently, comprising:
measuring a refractive index over a cross-section of at least one wall of the tubular strand at a first measuring position downstream of a first cooling section for the tubular strand when the tubular strand has not yet completely solidified;
measuring geometry values of the tubular strand at the first measuring position at at least one measuring location on the top side and at at least one measuring location on the bottom side of the tubular strand, wherein the geometry values comprise at least one of: (i) a wall thickness; (ii) an internal diameter; and (iii) an external diameter of the tubular strand;
determining a calibration correlation between the refractive index at the first measuring position and a ratio of the exit widths for extruded material on the top side and on the bottom side of the extrusion die; and
comparing a ratio of the exit widths set on the extrusion device for extruded material on the top side and on the bottom side of the extrusion die for the measured refractive index for a ratio of the geometry values measured on the top side and on the bottom side of the tubular strand with the calibration correlation,
wherein the measuring is done by a terahertz measuring apparatus.

20. The method according to claim 19, wherein the calibration correlation is determined for defined geometry values of the tubular strand.

21. The method according to claim 20, further comprising outputting a warning signal if a deviation of the geometry values measured at the first measuring position from the defined geometry values is ascertained.

22. The method according to claim 20, further comprising adjusting the calibration correlation if a deviation of the geometry values measured at the first measuring position from the defined geometry values is ascertained.

23. The method according to claim 19, wherein, the determining of the calibration correlation takes into account at least one of material parameters, production parameters, and cooling parameters of the tubular strand.

24. The method according to claim 23, wherein the material parameters include at least one of: (i) a thermal conductivity; and (ii) a thermal capacity, and wherein the production parameters include at least one of: (i) a temperature of the extrusion die; and (ii) a haul-off speed of the extrusion device.

25. The method according to claim 19, wherein the calibration correlation assigns the refractive index at the first measuring position to a nominal ratio of the exit widths for extruded material on the top side and on the bottom side of the extrusion die, such that the tubular strand comprises a uniform wall thickness profile over a circumference of the tubular strand following complete solidification of the tubular strand.

26. The method according to claim 25, wherein, if a deviation is determined between a resulting nominal ratio of the exit widths of the extrusion die for the refractive index measured at the first measuring position according to the calibration correlation and the ratio of the exit widths of the extrusion die, at least one of (i) the resulting nominal ratio for the measured refractive index according to the calibration correlation is displayed, and (ii) the extrusion device is automatically triggered in order to set the resulting nominal ratio for the measured refractive index according to the calibration correlation.

27. The method according to claim 26, wherein the calibration correlation further assigns the refractive index at the first measuring position to a ratio of the wall thicknesses on the top side and on the bottom side of the tubular strand at the first measuring position, wherein a weighting factor is utilized to convert between the ratio of the wall thicknesses on the top side and on the bottom side of the tubular strand at the first measuring position and the nominal ratio of the exit widths for extruded material on the top side and on the bottom side of the extrusion die, and wherein the weighting factor takes into account a different degree of sagging upstream of the first measuring position and downstream of the first measuring position.

28. The method according to claim 19, further comprising predicting an expected sagging of the tubular strand up to the complete solidification of the tubular strand based on a comparison of the geometry values measured at the first measuring position with the exit widths set on the extrusion device.

29. The method according to claim 28, wherein at least one of:
the predicted sagging and expected values of the measured geometry values in a completely solidified state of the tubular strand is displayed; and
the nominal ratio of the exit widths for extruded material on the top side and on the bottom side of the extrusion die according to the calibration correlation is adjusted based of the predicted sagging.

30. The method according to claim 19, wherein the refractive index is measured at the first measuring position on at least one of the top side and the bottom side of the tubular strand.

31. The method according to claim 19, wherein at least one of the refractive index and the geometry values is measured at a plurality of measuring locations over a circumference of the tubular strand.

32. The method according to claim 19, wherein the refractive index is determined from a comparison of the transit time of measuring radiation emitted by the terahertz measuring apparatus without a tubular strand arranged in the beam path of the measuring radiation with the transit time of the measuring radiation with a tubular strand arranged in a beam path of the measuring radiation.

33. The method according to claim 19, wherein the refractive index is determined by:
determining an optical wall thickness of the tubular strand with the terahertz measuring apparatus,
determining an external diameter and an internal diameter of the tubular strand with the terahertz measuring apparatus, and
determining the refractive index of the tubular strand from a comparison of the determined external and internal diameter with the determined optical wall thickness.

34. The method according to claim 19, wherein the geometry values of the tubular strand are determined from a transit time measurement of measuring radiation emitted by the terahertz measuring apparatus.

35. The method according to claim 19, further comprising measuring at a second measuring position at least one of:
the refractive index over the cross-section of at least one wall of the tubular strand;
the wall thickness of the tubular strand;
the internal diameter of the tubular strand; and
the external diameter of the tubular strand,
wherein the second measuring position is positioned downstream of the first measuring position along the longitudinal direction of the tubular strand, and wherein the tubular strand is substantially completely solidified at the second measuring position,
wherein the measuring is done using a further terahertz measuring apparatus.

36. The method according to claim 35, wherein at least one of the wall thickness, the internal diameter, and the external diameter of the tubular strand on the top side of the tubular strand and on the bottom side of the tubular strand is measured with the further terahertz measuring apparatus.

37. The method according to claim 35, wherein the calibration correlation is checked and, if necessary, corrected using the measuring results of the further terahertz measuring apparatus.

38. A device for carrying out the method according to claim 19, comprising:
the terahertz measuring apparatus; and
an evaluation apparatus configured to check the ratio of the exit widths for extruded material on the top side and on the bottom side of the extrusion die.
